(19) United States
(12) Patent Application Publication
(10) Pub. No.: US 2018/0050944 A1
(43) Pub. Date: Feb. 22, 2018

(54) METHODS FOR RECLAIMING PRODUCED WATER

(71) Applicant: Naveed Aslam, Houston, TX (US)

(72) Inventor: Naveed Aslam, Houston, TX (US)

(21) Appl. No.: 15/238,266

(22) Filed: Aug. 16, 2016

(51) Int. Cl. C02F 9/00; B01D 21/00; B01D 9/00; B01D 19/00

(52) U.S. Cl. CPC C02F 9/00; B01D 21/0042; B01D 9/0018; C02F 2101/32; B01D 21/0084; B01D 19/0005; B01D 19/0042; B01D 9/0009

(57) ABSTRACT

A method for treating produced water from a fracking operation is disclosed. The produced water is first fed to a compact separator for the removal of suspended materials. This produced water is then treated for dissolved gases and suspended oils before being fed to a crystallizer where salts are separated from the produced water thereby producing fresh water for reuse or other means. Alternatively, the produced water may be fed to a disinfection system and a concentrator depending upon the composition of the produced water.

### BACKGROUND OF THE INVENTION

Hydraulic fracturing is becoming a desirable method for extracting hydrocarbons. However, this method is being given scrutiny by public and regulatory agencies due to their extensive requirement for and consumption of water.

This problem is exacerbated in certain regions of the United States because there is a water shortage to contend with. The Permian Basin in Texas is one such area so there is a continuous need for methods that use water more efficiently in the hydraulic fracturing operations.

The present invention utilizes a compact, modular and movable integrated system to reclaim produced water in fracturing operations. This method is able to reduce almost all the fresh water requirement during fraccing operations while also reducing the costs associated with produced water collection and disposal.

### SUMMARY OF THE INVENTION

In a first embodiment of the invention, there is disclosed a method for treating produced water comprising the steps:

Feeding produced water to an intensified compact separator wherein suspended materials are removed from the produced water;

Feeding the produced water to a separation system wherein dissolved gas and suspended oil are separated from the produced water;

Feeding the produced water to a crystallizer wherein water and salts are separated from the produced water; and

Recovering the water,

In a second embodiment of the invention, there is disclosed a method for treating produced water comprising the steps:

Feeding produced water to an intensified compact separator wherein suspended materials are removed from the produced water;

Feeding the produced water to a separation system wherein dissolved gas and suspended oil are separated from the produced water;

Feeding the produced water to a disinfection system wherein bacterial count of the produced water is reduced;

Feeding the produced water to a concentrator wherein the produced water is concentrated;

Feeding the produced water to a crystallizer wherein water and salts are separated from the produced water; and

Recovering the water.

The average produced water composition is described as follows: i.e., minimum, maximum and average:

| Constituent | Average | Maximum | Minimum |
|---|---|---|---|
| COD (mg/L) | 3,000 | 7,900 | 300 |
| pH | 7 | 8 | 6 |
| TDS (mg/L) | 150,000 | 400,000 | 1,000 |
| TSS (mg/L) | 1,200 | 13,800 | 10 |
| O&G (mg/L) | 800 | 1,000 | 600 |
| Iron (mg/L) | 100 | 300 | 3 |
| Barium (mg/L) | 1,600 | 9,000 | 1 |
| Strontium (mg/L) | 2,000 | 6,300 | 40 |
| Sulfate (mg/L) | 1,200 | 15,000 | 10 |
| Sodium (mg/L) | 36,000 | 150,000 | 3,300 |
| Chlorine (mg/L) | 88,000 | 250,000 | 5,000 |
| Bicarbonate (mg/L) | 1,800 | 15,000 | 80 |
| Calcium (mg/L) | 10,200 | 74,000 | 300 |
| Total Organic Carbon (mg/L) | 800 | 7,200 | 60 |

The produced water is characterized by very high dissolved salts or solids. On average these amounts are around 150,000 PPM. With this amount of dissolved salts or solids, produced water is typically beyond the capabilities of a traditional reverse osmosis (RO) unit, therefore produced water reclamation processes may be an evaporative crystallization process or a crystallization process.

It should be noted that for evaporative crystallization, the heat of evaporation of water (40.65 KJ/mol) is six times more than heat of fusion (6.01 KJ/mol), therefore, it is likely that a water reclamation process based on direct or in-direct crystallization could be economical.

The produced water stream comes out of a Gas-Water-Solid separator so most of produced gases have already been removed from the produced water stream. However, there will be some dissolved gases like carbon dioxide which will be removed through aeration in this proposed process.

The produced water will be recovered from a fracking operation by conventional means. The produced water will typically contain dissolved and dispersed components of oil and dissolved formation minerals. The produced water will also contain production chemicals and dissolved gases as well as production solids and possibly biological life.

The produced water is fed to the intensified compact separator. The intensified compact separator will remove suspended materials that are present in the produced water.

The intensified compact separator is designed to remove the suspended material from the produced water stream. Suspended solids and other suspended impurities would be removed from the produced water stream along with oil and sludge. The intensified compact separator typically will have tilted submerged plates in a gravity separator. These plates could be 40 to 50 millimeters apart and set at an angle of 30 to 45 degrees from horizontal. The desire is that the flow between the plates is laminar.

The oil and suspended matter removal efficiency of the plates is further enhanced by corrugating them which will cause the suspended particles and oil droplets to coalesce on the plates. In this design type, the solids will settle down towards the upper surface of the plates while the lower-density oils float up towards the underside of the plate immediately above. The solids slowly migrate down the plate surface and will fall into a sludge hopper. The oil droplets rise into the top of the corrugations where they will coalesce with other droplets. This will increase the droplet size and increase the rise rate once they break out into water above the plates, thereby ensuring that the oil floats to the surface of the separator. This oil can be collected at the surface and removed by a skimmer.

The produced water that now is relatively free of suspended materials is fed to the separation system wherein suspended oil and dissolved gases are removed from the produced water. The separation system utilizes a combination of nitrogen gas and novel geometry thereby creating a flow pattern which leads to high separation efficiencies of dissolved gas and suspended oil.

The separation system is typically a column flotation device that consists of a vertically oriented cylinder to remove dissolved gases, oil and other particulate matter from the produced water stream. In this unit, the produced water will enter the vessel near the top and flow downward while nitrogen bubbles are introduced at the bottom of the vessel through a nozzle and float upwards.

The produced water stream containing oil contaminants (dispersed oil droplets and/or oil-coated solids) is populated with gas bubbles that rise to the surface of the vessel. As the bubbles rise, they collide with and cling to the oil contaminants thereby dragging them to the surface of the vessel. These floating oily contaminants can be skimmed off and removed from the vessel. The clean produced water exits the bottom of the vessel beneath the nitrogen gas entry point. Bubble formation and distribution can be achieved by using a specifically designed nozzle that uses the recycled cleaned produced water.

The produced water which is now free of suspended materials and suspended oil and dissolved gases is then fed to the crystallizer. The crystallizer is nitrogen based, namely liquid nitrogen so there is a source of liquid nitrogen in fluid communication with the crystallizer. The produced water can be reclaimed through a direct or in-direct crystallizer. Both these types of crystallizers are operating through liquid nitrogen (LIN). In case of an in-direct crystallizer design the LIN is used to cool the cooling fluid such as silicone oil, this cooling fluid is in a closed loop and provides a cooling effect in a crystallizing chamber where water and salt are crystallized out in a chamber. In order to operate this crystallizer for long periods of time it is fitted with a rotating scrapper which acts as a self-cleaning mechanism. The ice crystals/water slush is separated from heavier salt solution through buoyancy effects.

Another alternative could be a direct LIN based crystallizer. It is likely that LIN based crystallizer could be much more energy efficient unit then the in-direct self-cleaning device. The direct LIN based crystallizer will have no rotating component. LIN and gaseous nitrogen (GAN) will be used to create agitation and crystal separations. The direct LIN based design with a draft tube will ensure that lighter ice crystals are carried up while the heavier salt crystals settles down.

Both these crystallizer units utilizes the principles of eutectic freeze crystallization wherein the water and salt will be crystallized out. Essentially the water freezes through thermal contact with the liquefied nitrogen and as the water freezes it will reject the salt which will remain in a brine solution.

For both type of the crystallizers they are designed to be compact as well as self cleaning. Typically, these units will have two cooling zones, the first where water is crystallized out and water crystals will be separated. The salt solution then enters the second cooling zone where the temperatures are even lower which results in the salts precipitating out thereby producing salt free water. The resulting fresh water can be recycled and reused in the fracking operation while the resulting salts can be sold or disposed of in an environmentally responsible manner.

In an alternative embodiment to the invention, an oxygen-based disinfection unit and a concentrator are employed in fluid communication between the separation system which removes suspended oil and dissolved gases from the produced water and the crystallizer.

The oxygen-based disinfection unit will reduce the bacterial count of the produced water. This water is then fed to the optional concentration unit which will concentrate the produced water. This unit is in fluid communication with the source of liquefied nitrogen which feeds the crystallizer. The concentrator uses the cold provided by the liquefied nitrogen to concentrate the produced water and will typically be employed where there is a lower amount of dissolved solids in the produced water. The produced water from the concentrator is then fed to the crystallizer but may also be fed back to the suspended oil and dissolved gases separation unit.

Oxygen will be reacted with a substrate to form the disinfecting agent which in turn will be immediately consumed thereby removing biological contaminations from the produced water.

The system is modular in design and can advantageously be permanently mounted at an oilfield site where it could treat produced water that is recovered from downhill oil fracking operations. Alternatively, the system can be sized and mounted on an appropriate vehicle which would allow the produced water treating stem to be driven from fracking operation to fracking operation as needed by the operators of those operations. An appropriate skid and power source could be provided at each of these operations.

This method can typically process 3 to 13 gallon per minute (GPM) of produced water feed stream. On average 7.0 GPM will be treated. The produced water stream compared to a traditional waste water stream is not that high volume of flow, so a mobile, modular solution which can be deployed at each well site is a viable option.

This mobile modular system could therefore be mounted on a vehicle such as a trailer truck as a single skid. A semi flatbed may also be employed.

However, for a permanently mounted design a much larger capacity e.g., 500-1500 GPM is desirable so that for example several wells in the area could be tied to central treatment facility.

Alternatively, flow back water could be treated by the methods of the present invention.

The various components of the crystallizer unit could be made from plastics or polymeric materials or ordinary steel coated with fluoro polymers. Since this is a low temperature design for water reclamation there is little likelihood of scaling and fouling effects and therefore the unit does not require more expensive material further lowering the overall CAPEX for the unit.

Previous attempts at commercialization of indirect crystallizers to treat high total dissolved solids water were less successful due to the high CAPEX and OPEX involved in the separation of ice and salt crystals as well as the cooling loop and refrigerant compressor design.

The present invention avoids these difficulties because the separation of ice and salt is performed in the same unit using the same fluid thereby lowering CAPEX and OPEX by intensifying energy but also mass exchange in one unit.

Further the crystallizer of the present invention has a lower energy requirement compared to distillation or evaporative crystallizers as the latent heat of fusion of ice is only one seventh that of the latent heat of vaporization.

The lower operating temperatures further result in minimizing scaling and corrosion effects from the water present in the crystallizer chamber. This allows the operator to use lower cost materials of construction.

The design per the present invention allows for no pretreatment of the produced water before being treated in the crystallizer.

The present invention further provides for the recovery of salts in near pure form allowing for their reuse or sale for use in other applications.

The present invention provides for a modular and movable crystallizer allowing for the unit to be moved to where there is a need to treat produced water.

The present invention further provides a high turn down ratio or TDR. This reflects the maximum capacity to minimum capacity in terms of flow so a unit with good TDR is desirable as when the feed flow changes the unit can adjust and still perform the desired work without upset the operability of the unit.

### BRIEF DESCRIPTION OF THE DRAWINGS

FIG. 1 is a schematic of the process for treating produced water per the invention.

FIG. 2 is a schematic of an alternative process for treating produced water per the invention.

### DETAILED DESCRIPTION OF THE INVENTION

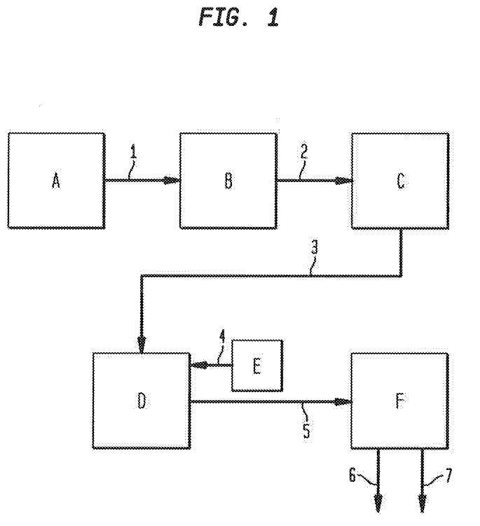

FIG. 1 is a schematic of a first embodiment of the present invention. Produced water from a fracking operation A is fed through line 1 to the intensified compact separator B. The intensified compact separator B will remove suspended materials from the produced water. The produced water now with the suspended materials removed is fed through line 2 to a nitrogen-based suspended oil and dissolved gases separation unit C.

The produced water which has suspended materials as well as suspended oil and dissolved gases removed from it is fed from the separation unit C through line 3 to the compact crystallizer D. The compact crystallizer D is in fluid communication with a source of liquefied nitrogen E through line 4. The compact crystallizer D contains two cooling zones. The first zone is present in the compact crystallizer D where the produced water is separated into fresh water and a brine solution from the salt crystals that precipitate out of the produced water. The fresh water and brine solution are fed through line 5 to the second cooling separation zone F which will separate the salt from the brine allowing for recovery of salts through line 6 and fresh water through line 7. The fresh water thus recovered may be used in the fracking operation or may be used in other industrial processes. The salts may be recovered and sold or disposed of in an environmentally responsible manner.

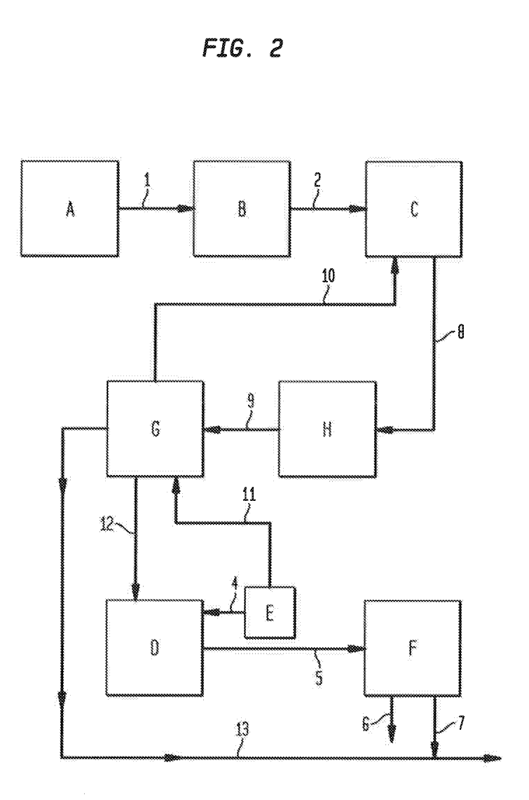

FIG. 2 is a schematic of the process of FIG. 1 with additional unit operations present therein. Accordingly like unit operations and conveyance means will bear the same number and letter scheme as in FIG. 1.

In FIG. 2, additional unit operations of oxygen-based disinfection and concentrator are present in the schematic of FIG. 1. The produced water that exits the suspended oil and dissolved gases separation unit C is fed through line 8 to an oxygen-based disinfection unit H which will operate to remove the amount of bacteria present in the produced water.

The produced water with this lower bacterial count is fed through line 9 to a concentrator G. The concentrator G uses liquefied nitrogen and is in fluid communication with the source of liquefied nitrogen E that supplies the crystallizer D through line 4. The concentrator G will be used to concentrate the produced water when the level of dissolved solids is lower than typical levels expected of produced water. The thus concentrated produced water is fed through line 12 to the crystallizer D.

Alternatively, the produced water from the concentrator G may be fed through line 10 to the suspended oils and dissolved gases unit C for further treatment. Depending upon the level of dissolved solids and their removal, the produced water may be purified sufficiently to be considered fresh water and this fresh water is fed from the concentrator G through line 13 where it will join with the purified water of line 7 from the separation unit F.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for treating produced water comprising the steps:
a) Feeding the produced water to an intensified compact separator wherein suspended materials are removed from the produced water;
b) Feeding the produced water to a separation system wherein dissolved gases and suspended oils are separated from the produced water;
c) Feeding the produced water to a crystallizer wherein water and salts are separated from the produced water; and
d) Recovering the water.

2. The method as claimed in claim 1 wherein the produced water contains 150,000 parts per million dissolved solids.

3. The method as claimed in claim 1 wherein the produced water contains dissolved and dispersed oil.

4. The method as claimed in claim 1 wherein the produced water is recovered from a fracking operation.

5. The method as claimed in claim 1 wherein the intensified compact separator is a gravity separator containing submerged plates.

6. The method as claimed in claim 5 wherein the submerged plates are corrugated.

7. The method as claimed in claim 5 wherein oil droplets are further removed from the produced water by the intensified compact separator.

8. The method as claimed in claim 1 wherein the separation system further removes dissolved gas from the produced water.

9. The method as claimed in claim 8 wherein the separation system is a flotation device.

10. The method as claimed in claim 8 wherein the suspended oils are removed from the separation system by skimming.

11. The method as claimed in claim 1 wherein water and salt are separated in the crystallizer.

12. The method as claimed in claim 11 wherein the salt is present in a brine solution.

13. The method as claimed in claim 11 wherein the brine solution is further crystallized thereby producing salt.

14. The method as claimed in claim 11 wherein fresh water is produced in the crystallizer.

15. The method as claimed in claim 1 wherein the intensified compact separator, separation system and crystallizer are mounted on a skid.

16. The method as claimed in claim 15 wherein the skid is mounted on a vehicle.

17. The method as claimed in claim 1 wherein 3 to 13 gallons per minute of produced water is treated.

18. A method for treating produced water comprising the steps:
a) Feeding produced water to an intensified compact separator wherein suspended materials are removed from the produced water;
b) Feeding the produced water to a separation system wherein dissolved gases and suspended oils are separated from the produced water;
c) Feeding the produced water to a disinfection system wherein bacterial count of the produced water is reduced;
d) Feeding the produced water to a concentrator wherein the produced water is concentrated;
e) Feeding the produced water to a crystallizer wherein water and salts are separated from the produced water; and
f) Recovering the water.

19. The method as claimed in claim 18 wherein the produced water contains 150,000 parts per million dissolved solids.

20. The method as claimed in claim 18 wherein the produced water contains dissolved and dispersed oil.

21. The method as claimed in claim 18 wherein the produced water is recovered from a fracking operation.

22. The method as claimed in claim 18 wherein the intensified compact separator is a gravity separator containing submerged plates.

23. The method as claimed in claim 22 wherein the submerged plates are corrugated.

24. The method as claimed in claim 22 wherein oil droplets are further removed from the produced water by the intensified compact separator.

25. The method as claimed in claim 18 wherein the separation system further removes dissolved gas from the produced water.

26. The method as claimed in claim 25 wherein the separation system is a flotation device.

27. The method as claimed in claim 25 wherein the suspended oils are removed from the separation system by skimming.

28. The method as claimed in claim 18 wherein the disinfection system is oxygen-based.

29. The method as claimed in claim 18 wherein the concentrator uses liquefied nitrogen to concentrate the produced water.

30. The method as claimed in claim 18 wherein water and salt are separated in the crystallizer.

31. The method as claimed in claim 30 wherein the salt is present in a brine solution.

32. The method as claimed in claim 31 wherein the brine solution is further crystallized thereby producing salt.

33. The method as claimed in claim 30 wherein fresh water is produced in the crystallizer.

34. The method as claimed in claim 18 wherein the intensified compact separator, separation system and crystallizer are mounted on a skid.

35. The method as claimed in claim 34 wherein the skid is mounted on a vehicle.

36. The method as claimed in claim 18 wherein 3 to 13 gallons per minute of produced water is treated.
